(19) United States
(12) Patent Application Publication
(10) Pub. No.: US 2008/0212970 A1
(43) Pub. Date: Sep. 4, 2008

(54) NON-LINE OF SIGHT OPTICAL COMMUNICATIONS

(75) Inventor: Isaac Shpantzer, Bethesda, MD (US)

Correspondence Address: CELIGHT, INC., 12200 TECH RD., SILVER SPRING, MD, 20904, US

(73) Assignee: CeLight, Inc.

(21) Appl. No.: 11/763,130

(22) Filed: Jun. 14, 2007

Related U.S. Application Data
(60) Provisional application No. 60/891,557, filed on Feb. 26, 2007.

(51) Int. Cl. H04B 10/00

(52) U.S. Cl. 398/118

(57) ABSTRACT

A non-line of sight (NLOS) communications system and method are provided. An ensemble of photodetectors is used to collect the light, scattered in the sky being illuminated by initial pulsed laser beam carrying information. Each detector collects scattered light from one area in free space along the initial light propagation line. The same bit of information is detected multiple times on multiple detectors during the pulse transmission along its propagation path. Signals received by multiple detectors are synchronized and processed in a digital signal processing unit. Improved system sensitivity and reliability is achieved by multiple registration of the same bit of information. Special selection of the areas in free space ensures detection of a single bit of information during the time equal to a bit period.

### CROSS-REFERENCE TO RELATED APPLICATIONS

The present invention claims the benefit of U.S. Ser. No. 60/891,557 filed Feb. 26, 2007, which are fully incorporated herein by reference.

### FIELD OF INVENTION

This invention relates generally to the systems and methods for free-space optical communications, and more particularly to non-line of sight (NLOS) communications for military and civilian applications. This type of communications can provide a robust covert communication link where it is of vital importance such as military operations in urban terrain.

### BACKGROUND OF THE INVENTION

U.S. Pat. No. 5,301,051 by Geller discloses a covert communication system that uses ultraviolet light as a medium for communication. Suitable wavelengths are chosen by examining atmospheric penetration, attenuation by clouds, presence of interfering sources, and ease of generation and detection.

It is well known that atmospheric gases such as ozone and oxygen strongly absorb light in the spectral range between 200 and 280 nm. It is called “solar blind” region of spectrum. It is beneficial to create a free-space communication link operating in this range since solar radiation will not interfere with the data transmission. Non-line of sight communication is based on the light scattering in atmosphere and detecting of at least some portion of the scattered light. Raleigh theory indicates a strong wavelength dependence of the scattering (˜λ⁻⁴) which means that blue light is scattered much more than red light. It is advantageous to use blue or UV light in NLOS communications since more light can be collected.

An optical communications transceiver of U.S. Pat. No. 6,137,609 comprises a transmitter that sends out the same information simultaneously in two channels with different wavelengths and a receiver for detecting and comparing the received data. Additional reliability of the communications is achieved by the transmission doubling.

Traditionally photomultipliers are used for UV light detection. Recently developed low noise high sensitive avalanche AlGaN photodiodes are compatible with the photomultiplier in their characteristics while providing setup compactness. US patent application No. 20050098844, which addresses manufacturing of such detectors, is incorporated herein by reference.

There is still a need for improved light detection schematics to enhance sensitivity and reliability of non-line of sight UV optical communications.

### SUMMARY OF THE INVENTION

The system and method are disclosed for non-line of sight optical communications with improved sensitivity and reliability. The sensitivity improvement is achieved by implementation of a novel receiver, which comprises a series of photodetectors. An ensemble of photodetectors is used to collect the light, scattered in the sky being illuminated by initial laser beam carrying information. The preferred wavelength operation range is from 200 to 280 nm. Each detector collects scattered light from one area in free space along the light propagation. In the preferred embodiment the areas of light collection do not overlap. The output signals from the photodetectors impinge a time delay unit, which synchronizes signals from different detectors. Each time delay introduced by the delay unit to each detector output signal corresponds to the time of flight for the light pulse from one detection area to another. In real systems with an operation range from tenth of meters up to kilometers, each delay is in the range from 10⁻¹⁰ to 10⁻⁸ sec. A digital signal processing unit combines all synchronized signals, decodes and displays the information encoded in the initial light beam. In the preferred embodiment the information is encoded in Amplitude-Shift keying (ASK) format.

In the preferred embodiment each detector collects light from an area in free space, which has essentially elliptical shape with major axis from 10 cm to 10 meters. The major axis of the elliptical area coincides with the direction of the initial light propagation. The length of the major axis is determined by the bit rate in the initial laser beam.

In the preferred embodiment one-dimensional array of N photodetectors is used in the detection scheme, where N is integer. In another embodiment two-dimensional array of N photodetectors is used. In the preferred embodiment the photodetectors are avalanche photodiodes. In another embodiments an array of photomultipliers or solid state photodiodes or semiconductors detectors are employed.

In another embodiment of the present invention a non-line of sight communications system is disclosed thai transmits information in two directions each having its azimuth and elevation angle. The information transmission in each direction can be a Wavelength Division Multiplexed (WDM) transmission, where each wavelength represents a separate information channel.

### BRIEF DESCRIPTION OF THE DRAWINGS

FIG. 1. A block diagram of a non-line of sight communications system with a receiver having multiple detectors.

FIG. 2. An illustration of initial pulse propagation.

FIG. 3. (a) A linear array of photodetectors, and (b) a two-dimensional arrangement of detectors.

FIG. 4. An optical receiver for non-line of sight communication system.

FIG. 5. An optical receiver with detectors having different apertures (a) and the same apertures (b).

FIG. 6. A block diagram of non-line of sight communications system with an initial beam split into two beams directed along the different azimuths and having different elevation angles.

### DETAILED DESCRIPTION OF THE PREFERRED EMBODIMENT

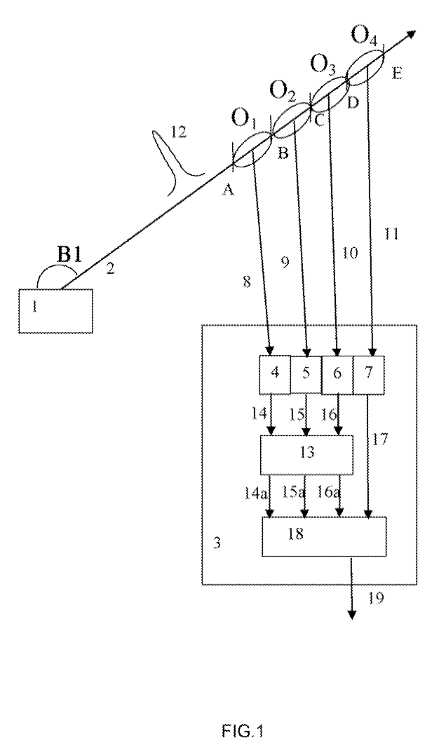

FIG. 1 illustrates the basic concept of the non-line of sight communications according to the present invention. Light source 1 irradiates an initial beam 2, which propagates at an elevation angle B1. In the preferred embodiment the light source generates pulsed ultraviolet light in the range from 200 to 280 nm. Laser AVIA 266-3 from Coherent, Inc. located in Santa Clara, Calif. can be used as a light source. In the preferred embodiment the initial beam transmits a signal in Amplitude Shift Keying (ASK) format. A receiver 3 includes a number of photodetectors 4-7. FIG. 1 shows four photodetectors as an example, however the photodetector system may include any N number of units, where N≧2. The function of the detector system is to collect light being scattered by the atmospheric inhomogeneities along the initial beam propagation and to convert the light into electrical signals. Each photodetector collects light from the area along the light beam 2. In the preferred embodiment each photodetector collects light from an essentially elliptical area. A first and a second elliptical areas O₄ and O₃ with corresponding major axes DE and DC are shown in FIG. 1. The major axes of the areas coincide with the direction of the initial beam propagation. In the particular example shown in FIG. 1 the photodetector 7 collects light 11 scattered along the light beam 2 from the area with the major axis DE. Similarly other photodetectors 4-6 collect scattered light from their areas with major axes AB, BC, and CD correspondingly. The present invention discloses a multi-detector signal registration, where the same pulse 12 is detected several times along its propagation path. It is detected by the photodetector 4 on the AB cut, by the photodetector 5 on BC cut, by the photodetector 6 on CD cut, and by the photodetector 7 on DE cut. The photodetectors 4-7 output electrical signals 14-17.

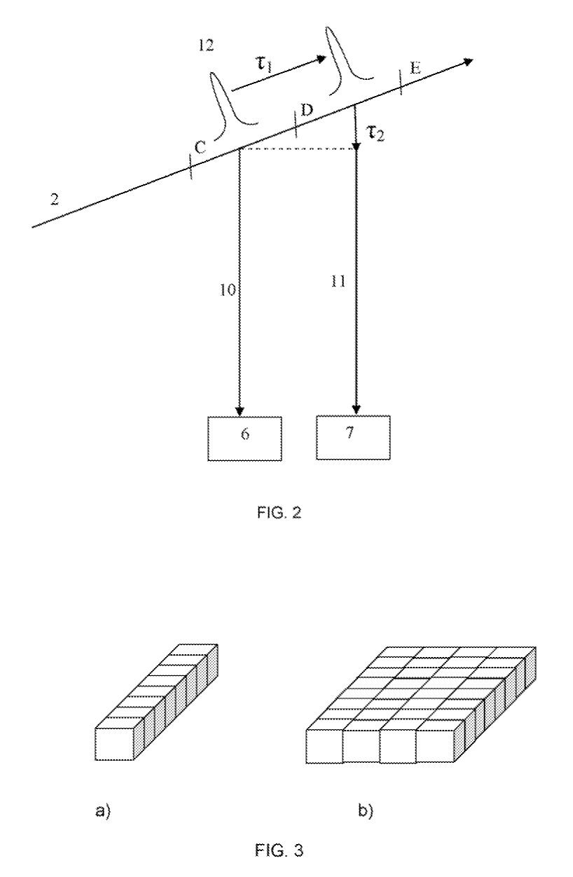

FIG. 2 illustrates the pulse 12 transmission along the propagation direction. The signal, detected by the photodetector 7, is delayed relative to the signal, detected by the photodetector 6, by the time of the light propagation from CD area to DE area τ₁ combined with the difference in optical paths τ₂ cause by the initial beam elevation. In our system the time τ₁ is a one bit period of the transmitted signal. Accordingly, the length CD (the major axis of the area) is a bit distance, which is defined as a product of V and τ₁, where V is a speed of light in air. In the preferred embodiment the length of the major axis is from 10 cm to 10 meters for each area. These numbers correspond to the optical transmission in the range from tenth of meters to kilometers.

Returning back to FIG. 1, a time delay unit 13 introduces different delays in signals 14-16 in order to synchronize them with the signal 17. The time delay unit outputs delayed electrical signals 14a-16a. Each of the signals 14a-16a is delayed relative to the signal 17 by the time delay being equal to the time difference in light propagation from the laser light source to the corresponding detector as shown in FIG. 2. In the preferred embodiment the first time delay is from 10⁻¹⁰ to 10⁻⁸ sec, each other delay is a multiple of the first time delay. These numbers correspond to the optical transmission in the range from tenth of meters to kilometers. Such delay duration can be provided by the digital delay unit SY89296U from company Micrel, Calif. or similar device.

A digital signal processing (DSP) unit 18 receives the signals 14a, 15a, 16a, 17 and recovers transmitted information. The unit 18 outputs a signal 19, which can be displayed or further transformed for audio or video presentation. In the preferred embodiment the signal is encoded using Amplitude Shift Keying (ASK) format, however any other format may be used such as Phase Shift Keying (PSK), Frequency Shift Keying (FSK), Pulse Position Modulation (PPM), Mark-space format or another. In the preferred embodiment each of the ASK modulated signals 14a-17 is analyzed in the DSP unit on the presence of an information bit within the predetermined time equal to the one bit period. Since the same pulse is detected N times (in our particular example four times) using N detectors, signal-to-noise ratio increases in \sqrt{N} times assuming that the noise is stochastic. Improvement of signal-to-noise ratio in the signal detection corresponds to the increased sensitivity and reliability of the detection.

The array of the photodetectors may be one-dimensional as shown in FIG. 3 (a). Alternatively, two-dimensional arrangement can be used as shown in FIG. 3 (b). Each photodetector in two-dimensional arrangement may be used to detect light scattered by independent areas along the initial beam propagation path. Alternatively, a group of photodetectors may detect the signal from the same area. In yet another embodiment the photodetectors may receive signals from overlapping areas. In the preferred embodiment the photodetectors 4, 5, 6 and 7 are avalanche diodes as described in US Patent Application No. 20050098844 by Sandvik, incorporated herein by reference. Alternatively any other type of solid state photodetector, semiconductor photodetector or photomultiplier can be used. Hamamatsu R928 Photomultiplier with a UV filter was used in the experimental testing of the present invention.

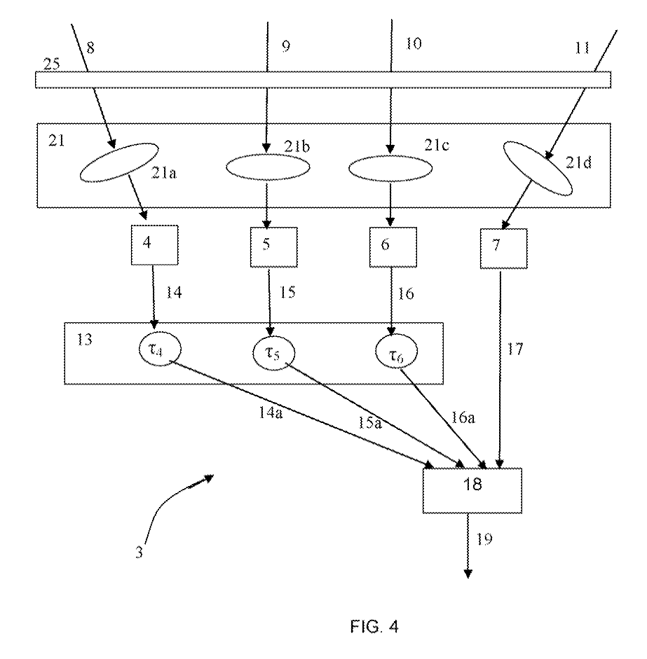

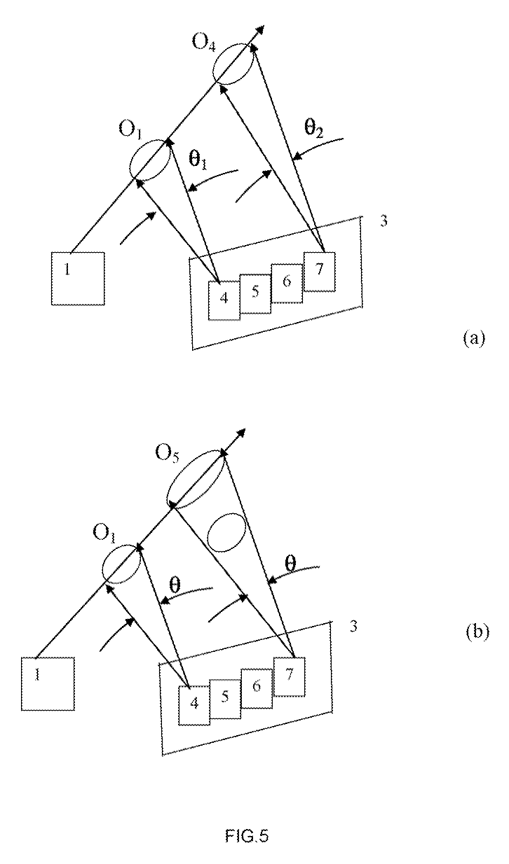

In the preferred embodiment the receiver 3 includes focusing element. It may be a multiple aperture element 21 as shown in FIG. 4, which comprises a set of optical elements 21a-21d. Collective optics is an important part of the receiver which allows to gather more energy on the photodetectors and to increase the system sensitivity. Different delay lines τ₄, τ₅, τ₆ shown in FIG. 4 are chosen in a way to synchronize signals 14-17. Each of the different time delays τ₄, τ₅ is a multiple of the first time delay τ₆. Output delayed signals 14a-16a and 17 enter the DSP unit 18 for data processing, information recovery and results displaying.

Optionally the receiver 3 may include a filter or a set of filters 25 to select a particular wavelength from incoming radiation. The filter 25 may serve as a shield from ambient light. Alternatively, when the initial beam is a wavelength division multiplexed (WDM) beam, the filter 25 may select a particular wavelength out of WDM signal.

In the preferred embodiment the photodetectors 4, 5, 6 and 7 have different apertures as shown in FIG. 5 (a). If the detectors have the same apertures θ, the size of the areas, from which the scattered light is detected, will be different as shown in FIG. 5 (b). In the present invention the length of the areas is equal to the bit distance, which defined as a product of the one bit period by the speed of light. The bit distance is the same along the initial beam propagation direction, and therefore the detector apertures need to be selected to meet this requirement.

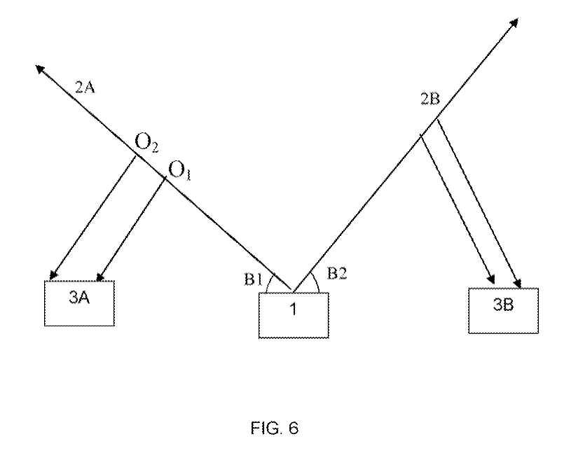

In one embodiment of the invention the initial optical beam consists of series of optical beams, each directed along its azimuth and has its own elevation angle. FIG. 6 shows the initial beam being split into two secondary initial beams 2A and 2B. The first part of the initial optical beam 2A is directed along an azimuth A1 towards the sky at an elevation angle B1 above the horizon. The Sight beam 2A is scattered on the atmosphere inhomogeneities in a free space along its transmission path, portions of the initial optical beam forming scattered light segments O₁ and O₂. A receiver 3A comprises a set of photodetectors and delay line units; it recovers information encoded in 2A. The receiver 3A may have a structure as shown in FIG. 4. Another part of the initial beam 2B transmits information in the similar manner, and this information is detected and recovered by a receiver 3B, the receiver 3B may have a structure as shown in FIG. 4. In general case, the initial beam can be split in any number of secondary initial beams, each of them carrying independent information. The information transmission along each direction can be a WDM transmission with a number of frequency separated channels.

In the preferred embodiment the receivers 3A and 3B comprise N detectors and a delay unit providing N delay lines to synchronize the detected signals. This provides \sqrt{N} times improvement in the detection sensitivity and reliability as discussed above.

The foregoing description of a preferred embodiment of the invention has been presented for purposes of illustration and description. It is not intended to be exhaustive or to limit the invention to the precise form disclosed, and obviously many modifications and variations are possible in the light, of the above teaching. The described embodiment was chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A receiver to receive information encoded in a pulsed collective optical beam being a combination of multiple elementary optical beams coming from different directions, the collective optical beam being formed as a result of an initial optical beam scattering on the atmospheric inhomogeneities, the initial optical beam being a monochromatic beam generated by a laser source, comprising:
at least a first and a second photodetectors, the first and the second photodetectors receiving a first and a second elementary optical beams respectively, an axis of the first and an axis of the second detectors being positioned at an angle to each other to receive the elementary optical beams coming from different directions; the first elementary beam being received from a first area in a free space and the second signal being received from a second area in the free space, the first and the second areas being at a distance of at least tenth of meters from the first and the second detectors; wherein a first detector aperture having a size to receive the first elementary beam coming from the first free space area with a length along the direction of the initial optical beam being larger than a length of a pulse of the first elementary optical beam;
the photodetectors outputting a first and a second electrical signals;
at least a first time delay unit introducing a first time delay in the second electrical signal to synchronize the first and the second electrical signals; the first time delay being equal to time difference in light propagation from the laser source to the first and the second photodetectors, determined by the angle between the first and the second elementary optical beams and by a time of the pulse propagation from one edge of the first free space area to another edge of it; the first time delay unit outputting a second delayed electrical signal; and
a digital signal processing unit combining at least the first electrical signal and the second delayed electrical signal and decoding the information being encoded in the initial optical beam.

2. A receiver according to claim 1, further comprising:
at least a first and a second optical elements receiving the first elementary beam and the second elementary beam respectively, collecting and focusing the first and the second elementary beams on the first and the second photodetectors respectively, the first and the second optical elements having a first and a second apertures, the first aperture being different than the second aperture.

3. A receiver according to claim 2, wherein the first and the second free space areas do not intersect, wherein the second aperture having a size to receive the second elementary beam coming from the second free space area having the same length as the first free space area, and a difference between the first and the second apertures is determined by a difference in distance from the first and second free space areas to the first and second photodetectors.

4. A receiver according to claim 1, wherein the first time delay is from 10⁻¹⁰ to 10⁻⁸ sec.

5. A receiver according to claim 1, wherein the initial optical beam has a wavelength in the range from 200 nm to 280 nm.

6. A receiver according to claim 1, wherein the first free space area and the second free space area are essentially elliptical areas with major axes having lengths from 10 cm to 10 meters.

7. A receiver according to claim 1, wherein the detector aperture is selected to image the first free space area having the length along the initial beam direction being equal to a product of a bit period in the initial beam by a speed of light in air and associated with the optical pulse propagation from one edge of the free space area to another along the initial beam propagation direction during a first detection time.

8. A receiver according to claim 6, wherein the first and the second photodetectors collect light from a cone, having the first and the second free space areas as cross sections.

9. A receiver according to claim 1, wherein the first and the second photodetectors are solid state devices.

10. A receiver according to claim 1, wherein the first and the second photodetectors are semiconductor devices.

11. A receiver according to claim 1, wherein the first and the second photodetectors are avalanche photodiodes.

12. A receiver according to claim 1, wherein the first and the second photodetectors are photomultipliers.

13. A receiver according to claim 1, further comprising:
N photodetectors, where N is integer, N photodetectors receiving N elementary optical beams each propagating at its angle in the free space, N photodetectors having different apertures and different angles of the detector axis, the detector axes coinciding with propagating angles of N elementary optical beams, N elementary beams originated from N free space areas located along the initial beam, the areas do not intersecting with each other, the length of each area along the initial beam propagation direction being larger than the length of the pulse, N photodetectors outputting N electrical signals,
N delay lines introducing N different delays in N electrical signals, each of N different delays being multiple of the first time delay, N delay lines outputting N delayed electrical signals and
the digital signal processing unit further combining N delayed electrical signals with the first electrical signal and the second delayed electrical signal; and
the digital signal processing unit decoding the information being encoded in the collective optical beam.

14. A non-line of sight optical communications system, comprising:
a laser light source, the laser light source outputting an initial optical beam transmitting information, the initial optical beam having at least a first part of the initial optical beam;
the first part of the initial optical beam being directed along an azimuth A1 towards the sky at an elevation angle B1 above the horizon, the first part of the initial optical beam being scattered on inhomogeneities in a free space along its transmission path, portions of the first initial optical beam forming scattered light,
at least a first and a second photodetectors each receiving a first and a second scattered light from a first and a second free space areas, the first and the second free space areas, both the first and the second free space areas located along the initial optical beam propagation direction and non-overlapping in free space, a first detector aperture having a size to receive the first elementary beam coming from the first free space area with a length along the direction of the initial optical beam being larger than a length of a pulse of the first elementary optical beam;
the first and the second photodetectors outputting a first and a second electrical signals;
a first time delay unit introducing a first time delay in the second electrical signal to synchronize the first and the second signals, the first time delay determined by a time of the pulse propagation from one edge of the first free space area to another edge along the axis;
the first delay unit outputting a second delayed electrical signal;
a first digital signal processing unit combining the first electrical signal and the second delayed electrical signal, the first digital signal processing unit decoding a transmitted information being encoded in the first part of the optical beam.

15. A non-line of sight optical communications system according to claim 14, further comprising the optical beam having multiple wavelengths.

16. A non-line of sight optical communications system according to claim 14, further comprising the first and the second free space areas having different shapes determined by the first and a second numerical apertures of a first and a second lenses forming images of these free space area.

17. A non-line of sight optical communications system according to claim 14, further comprising:
N photodetectors receiving N non-overlapping scattered light from N free space areas located along the initial optical beam propagation direction, where N is integer, N photodetectors having different apertures and different angles of the detector axis, the detector axes coinciding with propagating angles of N elementary optical beams, N photodetectors outputting N electrical signals;
the first time delay unit further introducing different time delays in N electrical signals and outputting N delayed electrical signals, each of the different time delays being multiple of the first time delay; the first time delay being determined by a time of a pulse propagation from one edge of the first free space area to another edge of the first free space area;
the first digital signal processing unit further combining N delayed electrical signals with the first electrical signal and the second delayed signal, the digital signal processing unit decoding a transmitted information being encoded in the initial optical beam.

18. A non-line of sight optical communications system according to claim 14, further comprising
at least a second part of the initial optical beam being directed along an azimuth A2 towards the sky at an elevation angle B2 above the horizon, the second part of the initial optical beam being scattered on inhomogeneities in a free space along its transmission path, portions of the second part of the initial optical beam forming scattered light;
at least a third and a fourth photodetectors each receiving a first and a second scattered light from the first and the second free space areas, the first and the second free space areas, both the first and the second free space areas located along the initial optical beam propagation direction and non-overlapping in free space, the first and the second free space areas having different length, and the third and the fourth photodetectors outputting a third and a fourth electrical signals;
a second time delay unit further introducing a second delay in the fourth electrical signal; the
second delay unit outputting a fourth delayed electrical signal; and
a second digital signal processing unit combining the third electrical signal and the fourth delayed electrical signal, the digital signal processing unit decoding an information being encoded in the second part of the initial optical beam.

19. A method of non-line of sight optical communications, comprising:
emitting an initial light beam in free space;
modulating an amplitude of the initial light beam with an information to be transmitted;
scattering the light beam on the atmospheric inhomogeneities along its transmission path and forming a scattered light;
receiving at least a first portion of the scattered light on a first photodetector and a second portion of the scattered light on a second photodetector, the first portion being collected from a first free space area and the second portion being collected from a second free space area, the first and the second free space areas non-overlapping in space, wherein the first and the second areas being at a distance of at least tenth of meters from the first and the second detectors; wherein the lengths of the first and the second free space areas are determined by a first and a second detector apertures;
the first photodetector and the second photodetector outputting a first and a second electrical signals;
delaying the second electrical signal relative to the first electrical signal by a time delay forming a delayed second electrical signal; the time delay being determined by a time of a pulse propagation from one edge of the first free space area to another edge of the first free space area; and
combining the first electrical signal and the delayed second electrical signal, decoding and displaying transmitted information.

20. A method of non-line of sight optical communications according to claim 19, where the amplitude modulating is performed in Amplitude Shift Keying format.
